(19) United States
(12) Patent Application Publication
(10) Pub. No.: US 2008/0041986 A1
(43) Pub. Date: Feb. 21, 2008

(54) Ejecting mechanism for container of shredding device

(76) Inventor: Joseph Y. Ko, Laguna Niguel, CA (US)

Correspondence Address: BIRCH STEWART KOLASCH & BIRCH, PO BOX 747, FALLS CHURCH, VA, 22040-0747, US

(21) Appl. No.: 11/450,422

(22) Filed: Jun. 12, 2006

(51) Int. Cl. B02C 23/00

(52) U.S. Cl. 241/100

(57) ABSTRACT

An ejecting mechanism for a container of a shredding device includes a driving element having a pivot and a suffering end for suffering a force, wherein when the suffering end is forced, the container disposed on the driving element will be driven to have a rotation around the pivot so that the container is also driven to be ejected out and be in a tilt state. Therefore, when it needs to clean the shreds in the container, the suffer end of the driving element can be forced by, for example, stepping thereon, for driving the container to be ejected out of the shredding device so as to facilitate a cleaning and also simplify the performing steps for cleaning the container.

### FIELD OF THE INVENTION

The present invention is related to a shredding device, and more particularly to an ejecting mechanism for an inner container inside the shredding device.

### BACKGROUND OF THE INVENTION

Owing to the age of knowledge economy, information becomes more and more powerful, and thus, maintaining secrecy of the information also becomes an important issue for the industry so that the damage caused by betraying can be prevented. Therefore, important and confidential information that are recorded on paper (or CD) must be destroyed after utilization, and generally, this is executed by a paper shredder (or CD shredder).

The structure of the conventional paper or CD shredder can be seen in ROC Patent Publication No. 489674 entitled “Composite double-functional paper shredder”. As shown in FIG. 1, a container is positioned inside the main body of the paper shredder for receiving the falling paper or CD shreds that are shredded by a shredding unit, and when the container is full, for taking out the container and emptying thereof, a cover at the lateral side of the main body must be opened.

Further referring to ROC Patent No. I225429 entitled “Paper shredder”, in which the paper shredder includes a shredder cover having a shredding unit for shredding paper, wherein an upper face of the shredder cover owns a paper inlet and a lower face has a shred outlet, and the two opposite side walls of the shredder cover have two symmetrical axles mounted thereon; a shred container positioned below the shredder cover for receiving the shredded paper, wherein the upper opening edge of the container have two axle bases mounted on opposite sides thereof for receiving the two axles of the shredder cover so that the cover can be rotated round the axles at the top of the container. In this case, when the container is full, for cleaning thereof, firstly, the user has to rotate the cover to form an opening and then lift the whole paper shredder for pouring out the shreds. However, it is obvious that lifting the whole paper shredder including the shredder cover (also the shredding unit) and the container just for cleaning the container every time is very inconvenient. Therefore, the mechanisms used for cleaning the shreds in the conventional paper shredders as described above are still needed to be improved.

### SUMMARY OF THE INVENTION

The object of the present invention is to provide a convenient mechanism for ejecting a container in which multiple steps needed to clean the container are significantly simplified so that the user can eject the container easily.

For achieving the object described above, the present invention includes a driving element having a pivot and a suffering end for suffering a force; and a container disposed above the driving element, wherein when the suffering end is forced to drive the driving element to have a rotation around the pivot, the container is also driven by the driving element to be ejected out and be in a tilt state. Therefore, when intending to clean the container, the suffering end of the driving element can be forced, for example, by stepping thereon, for driving the ejection of the container out of the shredding device so as to facilitate the user to lift thereof.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a structural drawing showing a preferred embodiment according to the present invention;

FIGS. 2A˜2B are structural drawings showing the preferred embodiment according to the present invention; and

FIGS. 3A˜3B are practical drawings showing the preferred embodiment according to the present invention.

### DESCRIPTION OF THE PREFERRED EMBODIMENT

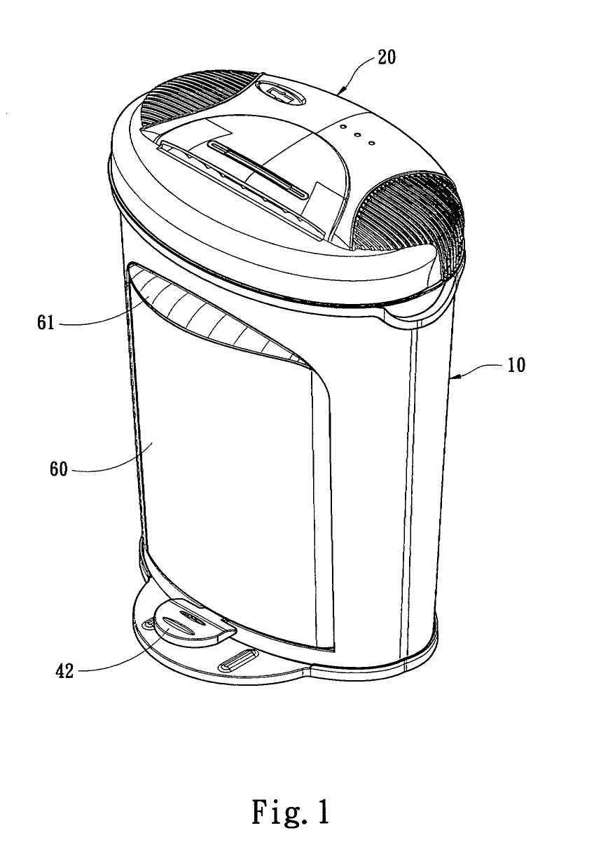

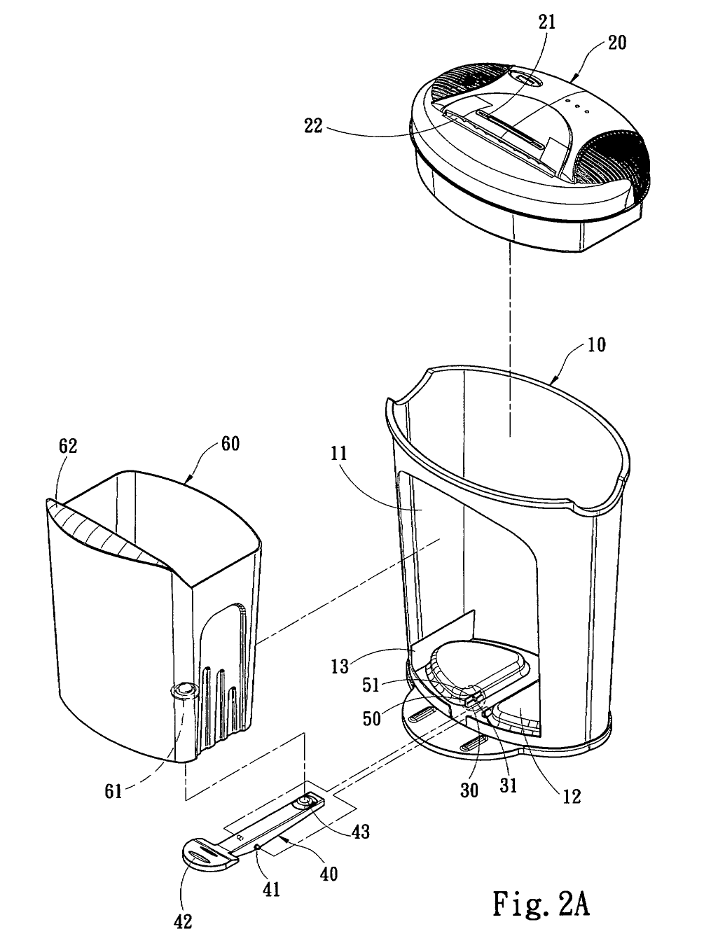

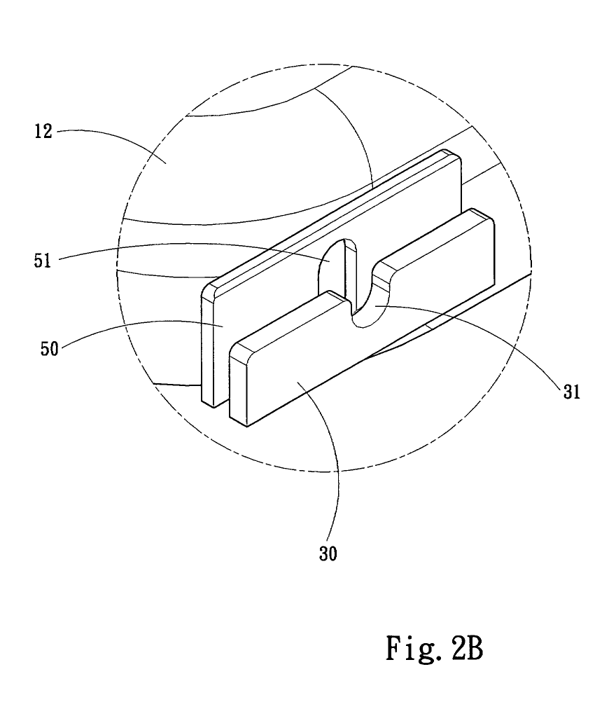

Please refer to FIG. 1, which is a structural drawing showing a preferred embodiment of the present invention. In this embodiment, the shown shredding device includes a hollow main body 10 with a shredding unit 20 mounted thereon, wherein the shredding unit 20 has a CD inlet 21 and a paper inlet 22 for achieving two functions. Further, the main body 10 has an surface opening 11 mounted on the lateral surface thereof and two protruding portions 12 mounted on the lower surface thereinside (as shown in FIG. 2A), wherein a supporting block 30 is located between the two protruding portions 12. Moreover, a groove 31 (as shown in FIG. 2B) is mounted on the supporting block 30, a driving element 40 is pivotally mounted on the groove 31, and an axle 41 is laterally mounted on the driving element 40 for rejecting to the groove 31 so that the driving element 40 can be pivoted between the two protruding portions 12. Also, a suffering end 42, which is exposed through the surface opening 11, is mounted on the driving element 40. In addition, a positioning piece 50 is mounted between the supporting block 30 and the protruding portions 12, and the positioning piece 50 has a guiding groove 51 mounted thereon for rejecting to the axle 41 so that the axle 41 and the positioning piece 50 may form a position-limiting relationship. Furthermore, a container 60 is located below the shredding unit 20 and is disposed above the two protruding portions 12 and the driving element 40, wherein the lower edge of the container 60 and the surface of the driving element 40 respectively have an indentation 61 and a positioning protruding-portion 43 which are matching to each other in shape, so that the container 60 and the driving element 40 can have a position-limiting relationship. In addition, a limiting piece 13 for position-limiting the container 60 is mounted between the inner side wall of the main body 10 and the protruding portion 12, thereby the container 60 can be stably disposed in the main body 10.

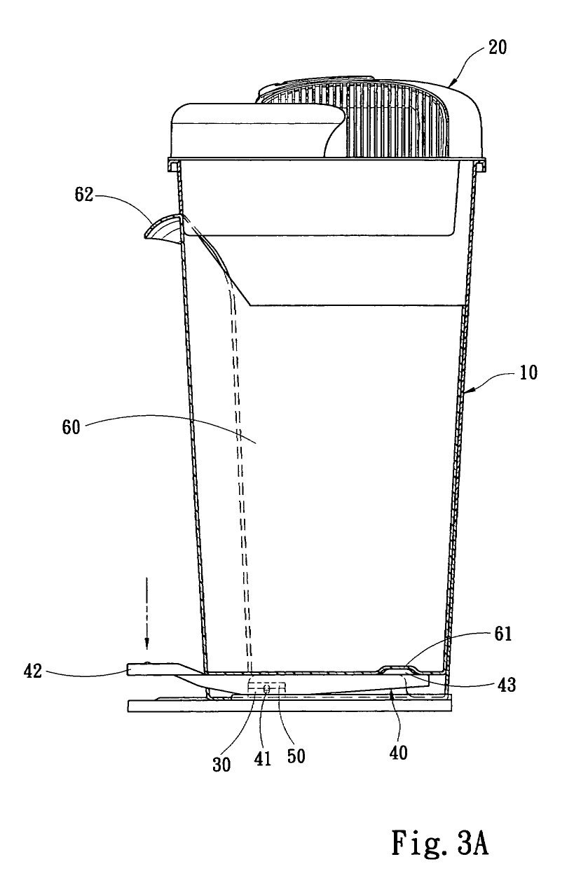

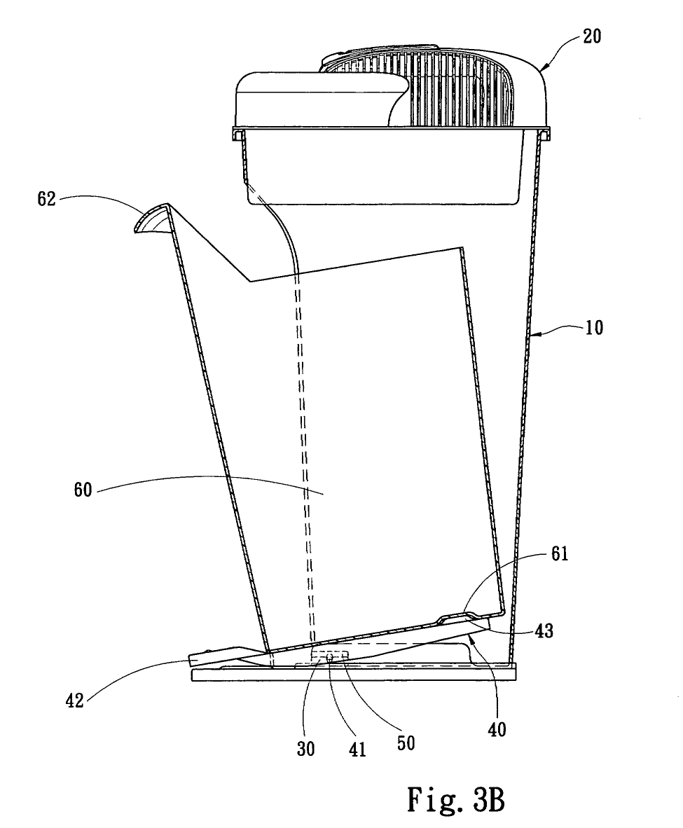

Please refer to FIGS. 3A˜3B which show the practical drawings of the preferred embodiment in the present invention. As shown, in a normal condition, the container 60 is located at the inner side of the surface opening 11 (as shown in FIG. 3A). Then, as the container 60 is full, a force can be applied on the suffering end 42 of the driving element 40, for example, by stepping thereon, to force the driving element 40 to have a rotation around the axle 41, and then through the matching between the indentation 61 at the lower edge of the container 60 and the positioning protruding-portion 43 at the surface of the driving element 40, the container 60 can be driven to expose out of the main body 10 through the surface opening 11 (as shown in FIG. 3B). Furthermore, a protruding edge 62 also can be mounted on the upper end of the container 60 for facilitating the user to lift up thereof, and thus, since the container 60 is not fixed inside the main body 10, for lifting up the container 60 and pouring out the shreds therein, the user only needs to apply a force to the protruding edge 62.

In the aforesaid, the present invention provides a mechanism for quickly ejecting the container 60 by stepping on the suffering end 42, through which the driving element 40 can be driven to have a rotation around the axle 41 so as to quickly eject the container 60. Therefore, the user can conveniently lift up the container 60 and pour out the shreds therein. According to the mechanism of the present invention, the steps needed to empty the container 60 of the shredding device can be significantly simplified and therefore more conformed to the requirements of the user. Besides, the application field of the present invention is not limited to be the shredding device, the ejecting mechanism also can be applied to other devices such as trash can, clothes recycling box, for also achieving a quick ejection.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An ejecting mechanism for a container of a shredding device, which has
a hollow main body and a container mounted inside the main body, the ejecting mechanism comprising:
a driving element for carrying the container which having a pivot located inside the main body and a suffering end for suffering a force,
wherein when the suffering end is forced, the container is driven to have a rotation around the pivot so that the container is also driven to have an ejection out of the main body to be in a tilt state.

2. The ejecting mechanism as claimed in claim 1, wherein the pivot is an axle mounted on lateral surface of the driving element.

3. The ejecting mechanism as claimed in claim 1, wherein the container has a protruding edge mounted on an upper edge thereof for applying a lifting force.

4. The ejecting mechanism as claimed in claim 1, wherein the lower edge of the container and the surface of the driving element are respectively formed an indentation and a positioning protruding-portion, which are matched to each other in shape, so as to have a positioning relationship between the container and the driving element.

5. A shredding device, comprising:
a hollow main body having a surface opening mounted on a lateral surface thereof;
a driving element having a pivot located inside the main body and a suffering end exposed out of the main body through the surface opening for suffering a force; and
a container disposed on the driving element,
wherein when the suffering end is forced, the driving element is driven to have a rotation around the pivot so that the container is also driven to have an ejection out of the main body through the surface opening.

6. The ejecting mechanism as claimed in claim 5, wherein the main body further comprises two protruding portions mounted on the lower surface thereinside, and a supporting block disposed between the two protruding portions and having a groove mounted thereon, wherein an axle which is mounted on the lateral surface of the driving element is rejected to the groove.

7. The ejecting mechanism as claimed in claim 6, wherein the main body further comprises a positioning piece located between the supporting block and the protruding portion and having a guiding groove mounted thereon, wherein the axle is rejected to the guiding groove for forming a position-limiting relationship with the positioning piece.

8. The ejecting mechanism as claimed in claim 5, wherein the main body further comprises a limiting piece mounted at the lateral side thereinside for position-limiting the container.

9. The ejecting mechanism as claimed in claim 5, wherein the container in a normal state is located at the inner side of the surface opening.

10. The ejecting mechanism as claimed in claim 5, wherein the container has a protruding edge mounted on the upper edge thereof for applying a lifting force.

11. The ejecting mechanism as claimed in claim 5, wherein the lower edge of the container and the surface of the driving element are respectively formed an indentation and a positioning protruding-portion, which are matched to each other in shape, so as to have a positioning relationship between the container and the driving element.
